(19) United States
(12) Patent Application Publication
(10) Pub. No.: US 2014/0373437 A1
(43) Pub. Date: Dec. 25, 2014

(54) Blossom Thinning Apparatus and Method

(71) Applicant: Phillip John Miller, Manistee, MI (US)

(72) Inventor: Phillip John Miller, Manistee, MI (US)

(21) Appl. No.: 14/095,071

(22) PCT Filed: Jun. 7, 2011
(86) PCT No.: PCT/US2011/039425

§ 371 Date: Sep. 11, 2014

(51) Int. Cl. A01G 3/08

(52) U.S. Cl. CPC A01G 3/08
USPC 47/1.43

(57) ABSTRACT

What is provided is a thinning apparatus and method, comprising: a rod with a plurality of recesses spaced at multiple locations long its length and spaced at one or more positions around its perimeter, and an attachment end capable of removably attaching said rod to a handheld rotating power tool; and a plurality of flexible tubular members attached to said rod in said recesses; said rod is capable of being rotated by said rotating power tool about said perimeter; said flexible tubular members are capable of being placed in contact with one or more blossoms or green fruit and removing said one or more blossoms or green fruit by said contact during said rotation; and said apparatus is capable of being handheld, including during said rotation and said removal, and being manually maneuvered to multiple angles with respect to said one or more blossoms or green fruit during said rotation.

### FIELD OF THE INVENTION

This disclosure relates to a device for thinning blossoms and /or green fruit on trees, shrubs, bushes or other plants, such as fruit trees.

### BACKGROUND OF THE INVENTION

As part of the fruit production cycle of a fruit tree, bush and/or shrub, flower buds may appear on the tree, often in clusters, and the buds may grow and open up into blossoms. After the tree blossoms, the blossoms may be pollinated and the fruit tree may set or produce fruit, which may begin as green fruit, be grown to maturity, and harvested. Each blossom cluster is capable of creating several tiny pieces of fruit. It is desirable for fruit trees, including but not limited to peach, pear, apple, nectarine, apricot, orange, grapefruit, lemon, lime and cherry trees, to produce larger and healthy fruit, rather than smaller or less robust fruit, for more appealing marketplace fruit offerings. It is desirable to prevent damage to a fruit tree and its limbs from bearing too many pieces of fruit.

With stone fruits (those with pits in their centers), a goal may be to reduce the crop load upon a tree in order to improve fruit size. For example, a peach tree may be pruned of green fruit when it is about the size of a dime to create about eight inches between fruit pieces on a limb. With pome fruits, such as apples or pears, a goal may be to achieve return blooming by the tree in following years. In this sense, blossom or green fruit thinning may maximize a grower's return on the fruit.

Accordingly, it may be desirable to prune a fruit tree so that each blossom cluster produces fewer fruit, such as but not limited to, only one piece of fruit per blossom cluster. This may be accomplished through blossom thinning or green fruit thinning. At the same time, removing too many blossoms or green fruit may result in a smaller than desired load, and some removal techniques or apparatuses may cause damage to the fruit tree, which may negatively impact year-to-year production by diminishing return blossoms and/or fruit in years to follow.

Blossom thinning occurs during the period that the blossoms are blooming By removing some of the fruit tree blossoms, the removed blossoms will not result in fruit. In this manner, fewer pieces of fruit will compete for growth on the tree, and the remaining fruit from the intact blossoms may be larger and healthier than if no blossoms had been removed and all blossoms had resulted in fruit. Blossom thinning may be accomplished during various times during the blossom cycle, such as when the blossoms first appear and/or are in a “popcorn” stage or when the blossoms are in full bloom. Growers differ over which blossoming stage is optimal for effective thinning.

Fruit thinning, also known as green fruit thinning, generally occurs when the fruit is small and not yet mature or ready for harvesting. After the blossom phase, when green fruit is thinned, removing some pieces of small and not yet mature fruit may result in larger and healthier fruit for the remaining pieces. Green fruit thinning may take place when the green fruit first appears, and/or after it has grown to a less than full size and maturity. For example, for a peach tree, green fruit may be removed when it is approximately the size of a dime or quarter in diameter. Growers differ over what size of green fruit is optimal for effective thinning, and it also varies depending upon the type and/or variety of fruit. Growers differ over which green fruit growth stage is optimal for thinning, and different growers may thin the green fruit at different stages as well as different sizes of development. Claimed subject matter is not intended to be limited to use for a particular size or development stage of green fruit.

Fruit harvesting devices for ripe and green fruit include large tractor pulled machines, which act to shake the fruit tree in an attempt to knock fruit off of the tree. Generally, these shakers operate by using clamping means to grip the tree trunk and shake it until the fruit falls into a tarp or other collector positioned below the tree. Other shakers include limb shakers, drum shakers, or spiked drum shakers. Where fruit is ripe, it will generally fall from the tree with less rigorous shaking than where the fruit is green. As such, attempting to use a fruit tree shaker for green fruit may cause damage to the fruit tree due to overzealous shaking.

Additionally, while effective for harvesting mature fruit, shakers are not as effective if used for green fruit thinning as they do not selectively remove fruit but remove all that will shake off of the tree at a given level of shaking intensity. The user has little to no control over which pieces of green fruit fall, and too many or too few pieces falling may result from use in this manner. Further, the user has little to no control over the spacing upon tree limbs of the remaining green fruit, and optimal or desired spacing to maximize fruit growth and/or yield is generally not possible.

Similarly, attempting to use a fruit tree shaker for blossom thinning may likely result in too many blossoms falling from the tree, as the entire tree is shaken at once. This likely may not produce optimal yield. Because the user has little to no control over which blossoms are removed from the tree, the user has little to no control over the spacing upon tree limbs of the remaining blossoms. As such, optimal or desired spacing to maximize fruit growth, yield and/or return blossoms is generally not possible.

Fruit tree shakers are cumbersome, often composed of numerous complicated mechanical and electrical pieces that require maintenance and which may malfunction, and they generally must be pulled by a tractor or other moving vehicle in order to be moved tree-to-tree for operation. They may result in bark damage to the tree. While appropriate for harvesting mature fruit, the added tractor fuel, shaker maintenance, lack of control over which pieces of green fruit or blossoms remain on the tree which likely results in a less than an optimal yield, and potential damage to the fruit trees from shaking significantly increases expense to the grower for fruit tree thinning by a shaking apparatus.

Prior art green fruit or blossom thinning also includes chemical thinning methods, whereby chemicals are sprayed on the fruit trees to eliminate blossoms and/or green fruit. Chemical thinning may be used, for example, on apple trees. However, chemical thinners may not be effectively used in all weather conditions, such as during rain. Further, some growers, such as but not limited to growers producing organic fruit, do not employ chemical thinners for environmental reasons, including worker exposure to the chemicals. Chemical thinning generally requires follow-up hand thinning.

Prior art fruit thinners also include high pressure water streams. High pressure water streams may thin fruit by using a high pressure hose, such as a power washer, to spray blossoms off the trees.

Prior art methods of blossom thinning include labor intensive hand thinning, whereby a worker picks blossoms off of a fruit tree one or a few at a time by manually pulling or pinching the blossoms off of the tree with his/her hand. This method is labor intensive, and thinning the blossoms on a single tree, let alone an entire orchard, may take many hours. While hand thinning may be accurate, as each blossom may carefully be selected for removal, this method increases labor expenses for a grower. Some workers have been known to hit fruit trees with baseball bats, sticks or hooked tools in attempts to knock blossoms off of fruit trees, but damage may often result to the fruit tree from this technique, the user may generally lack control over which blossoms fall, and it still is labor intensive.

Prior art blossom thinning devices include mechanical thinners which, like the fruit harvesters, are large tractor pulled machines. These blossom thinning machines generally are large and are not capable of being handheld during use. They typically are composed of numerous complicated mechanical and electrical pieces, such as hydraulic motors, proportional flow control valves, sensors and controls that require maintenance and which may malfunction, and they generally must be pulled by a tractor or other moving vehicle in order to be moved tree-to-tree for operation.

The tractor drawn mechanical thinners are approximately ten feet tall in most embodiments, and they are too heavy and large for a human to pick up and carry. These known mechanical thinners include a large vertical “U” shaped piece that has one roller having multiple spines of strings, or a rotating rope curtain, attached thereto. Other designs include multiple rollers attached to the vertical piece, with each roller having multiple strings at multiple locations along the roller. The large vertical piece may be rotated such that the strings act as whips and/or swing to knock blossoms off of the fruit tree.

The strings used for thinning on these mechanical thinners are similar to those used on a string trimmer and typically made of cords threaded through a plate that may be made of nylon, molded plastic, coiled plastic cords, rope, cord, or other like materials. Some strings are too harsh on the fruit tree and result in damage to other blossoms that they contact, yet which remain on the tree and from which mature fruit was desired. On these machines, the strings may be 20 inches or longer, spanning four feet overall in operation, which also may decrease accuracy and the ability to reach many portions of the tree.

In order for these large mechanical thinners to be effective, the fruit trees must be pruned to accommodate their large size, such as to remove tree branches and wood from alleys between trees and to create a perpendicular or quadrilateral “V” shape on the tree trunk, so that the machine does not scrape the wood or otherwise damage the trees. Often the mechanical thinners are not able to reach some tree branches and blossoms due to their large size and fixed position relative to the tractor, which may be vertical, horizontal or angled in various designs.

Hours of research has been performed to attempt to discover more effective angles, rotation speeds, tractor speeds, number of rows of strings, number of strings per row, and string placement for these machines, measured from yield blossom thinning, flower density, fruit set and yield. Over thinning may occur with the wrong machine speeds and settings, which may be a trial and error determination depending upon the size and shape of each tree. They lack maneuverability, and the results are not predictable as trees are easily over thinned due to the user lacking control over the large device and/or only thinned in particular places since the mechanism is fixed in place and only able to reach a portion of the tree. Further, strings that do not penetrate the tree canopy may hit the outer branches too fast and/or with too much force, causing damage to the tree. The added tractor fuel, mechanical thinner maintenance, potential damage to the remaining blossoms from the rigid strings employed by the mechanical thinning machine which have been known to damage the fruit tree yield, and inability to reach some tree branches and blossoms due to the large size of the mechanical thinning machine, increases expense to the grower. Most growers do not view these machines as a complete blossom thinning solution because they are not capable of thinning all blossoms desired for optimal fruit production, and follow-up hand thinning is needed.

An earlier handheld fruit thinning device includes a rotating head with vertical spiral ribs or threads (similar to a screw) for thinning green fruit. It included an electric motor and a drive shaft, and it rotated in use. It did not include string elements. It was generally not capable of thinning more than one blossom cluster at a time due to its shape. The head was rigid and made of metal or plastic, not flexible, which was harsher on the fruit tree and capable of causing it damage.

Accordingly, there exists a need in the art for a handheld blossom thinning apparatus, whereby a user does not need to use a tractor or other motor vehicle to pull the apparatus tree-to-tree for use. There exists a need in the art for a handheld blossom thinning device that is less expensive to purchase, operate and maintain than tractor pulled blossom thinning machines. There exists a need in the art for a handheld thinner that is not too heavy for a user to carry and not too large for a user to be able to maneuver. There exists a need in the art for a blossom thinning apparatus and method whereby the user may substantially control which blossoms are being removed to attempt to maximize crop yield and minimize damage to remaining blossoms as well as return blossoms year-to-year. There exists a need in the art for a handheld device having fewer components requiring maintenance than a large tractor pulled thinning machine. There exists a need in the art for a handheld thinning apparatus that, unlike chemical thinners, may be used in substantially all weather conditions and substantially minimizes environmental impact more than a chemical thinning agent may be capable of accomplishing. There exists a need in the art for a handheld blossom thinning device to decrease labor hours that would be expended from hand thinning without such an apparatus. There exists a need in the art for a handheld blossom thinning apparatus that is small enough and maneuverable enough to reach tree branches and blossoms that a large mechanical thinning machine fixed relative to the tractor pulling it cannot reach for thinning.

### SUMMARY OF THE INVENTION

A handheld apparatus and method for thinning blossoms and/or green fruit on trees, shrubs and/or bushes, such as but not limited to, fruit trees is provided.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is an elevational view of an embodiment of a blossom thinning device;

FIG. 2 is a side view of a rod that may be used with one or more embodiments of a blossom thinning device;

FIG. 2A is a cross sectional view of an attachment end of the rod of FIG. 2 in accordance with an embodiment of a blossom thinning device;

FIG. 3 is a side view of a rod that may be used with one or more embodiments of a blossom thinning device;

FIG. 4 is an elevational view of an embodiment of a blossom thinning device in rotational use;

FIG. 4A is a cross sectional view of the blossom thinning device embodiment in FIG. 4; and

FIG. 5 is a side view of a multi rod embodiment of a blossom thinning device.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Referring to FIG. 1, a thinning apparatus embodiment is shown. Thinning tool 10 may be used to thin blossoms and/or green fruit on trees, shrubs, bushes or other plants. Thinning tool 10 is comprised of a rod 100. Rod 100 has a length 102 and a perimeter 104. In some embodiments, rod 100 has a hollow interior, such that it is substantially tubular in shape. In other embodiments, rod 100 has a substantially solid interior. In the embodiment shown in FIG. 1, the perimeter 104 of rod 100 is substantially circular in shape. However, perimeter 104 may be other shapes, such as but not limited to, substantially square, triangular, pentagonal, hexagonal, octagonal, oval, rectangular, by way of example, and many other shapes are possible in various embodiments. Rod 100 may be made of various materials known in the art, including but not limited to aluminum, titanium, steel, plastic, PVC, wood, galvanized iron, fiberglass, copper tubing, and other materials that are rigid and of a sufficiently light weight so as to allow thinning tool 10 to be handheld during use. Rod 100 may be of different lengths 102. Some embodiments have a length 102 that is two feet long, four feet long, or six feet long, and other lengths are possible within the scope of this application. Claimed subject matter is not so limited. Generally, length 102 is sufficiently short enough to allow tool 10 to be handheld during use. Rod 100 may be of different diameters. For example, rod 100 may be ½ inch in diameter or ⅝ inch in diameter. Claimed subject matter is not so limited.

Thinning tool 10 may have a plurality of recesses 106, each capable of containing a flexible tubular member 108 therein. In some embodiments, recesses 106 may be comprised of holes extending through the diameter of rod 100. In other embodiments, recesses 106 may be grooves, divets, notches or other cavities capable of accepting and/or retaining flexible tubular members 108 therein. In some embodiments, flexible tubular members 108 may be affixed or fastened in recesses 106 by various means, including but not limited to, adhesives, thermosetting adhesives, glue, epoxy, thermosetting polymers, bonding agents, cement, staples, or other fasteners or fastening means known in the art. In some embodiments, flexible tubular members 108 may be attached to rod 100 by stringing them through washers or other members that may be welded or otherwise attached to rod 100. Flexible tubular members 108 may be removably or permanently fastened to recesses 106 in various embodiments. Flexible tubular members 108 may be placed in recesses 106 merely by passing therethrough, where recesses 106 are holes through the diameter of rod 100, without further fastening means to secure them in place. In other embodiments, flexible tubular members 108 may pass through holes in rod 100 and also be affixed with fastening means known in the art. Claimed subject matter is not intended to be limited to a particular manner of placing or maintaining flexible tubular members 108 in recesses 106.

Other embodiments may include a sheath (not shown), placed around rod 102, through which flexible tubular members 108 may be threaded or otherwise retained, such that the sheath retains flexible tubular members 108 about rod 100. The sheath grips rod 100 such that it rotates with rod 100 during rotational use. The sheath may be replaced, as needed, to replace flexible tubular members 108. The sheath may be flexible, such as but not limited to, constructed of rubber, synthetic rubber, polyethylene, plastics, cotton roping, weaving of animal or human hair, or other flexible materials known in the art, or it may be rigid and constructed of aluminum, titanium, steel, wood, metal springs (such as those that would be used as a door stop), copper tubing, galvanized iron, or fiberglass, or other rigid materials known in the art. In this manner, flexible tubular members 108 may be retained about the perimeter 104 of rod 100 without recesses 106 in some embodiments.

Flexible tubular members 108 may be made of various flexible materials known in the art, including but not limited to, polyethylene tubing, plastic tubing, synthetic rubber tubing, rubber tubing, fiberglass, copper tubing, cotton roping, or other materials flexible in nature. In various embodiments, flexible tubular members 108 are made of a soft material so as to be capable of relatively gently removing blossoms from a fruit tree while causing no or minimal damage to the tree. Flexible tubular members 108 may be of various diameters. For example, in some embodiments, flexible tubular members 108 have a ¼ inch outer diameter and ⅛ inch inner diameter. In other embodiments, flexible tubular members may have a ¾ inch outer diameter and ⅝ inch inner diameter. Claimed subject matter is not limited to a particular diameter. Some embodiments may include flexible tubular members 108 that are not tubular is shape, but are instead solid rather than having a hollow interior. However, flexible tubular members 108 should be of size, shape and material so as to be capable of removing blossoms and/or green fruit with little, minimal or no damage to the fruit tree and remaining intact blossoms and/or green fruit. Flexible tubular members 108 may be of various perimeter shapes, including but not limited to circular, square, triangular, octagonal, pentagonal, oval, rectangular, and other various shapes. Claimed subject matter is not so limited. Flexible tubular members 108 are generally lightweight.

In some embodiments, flexible tubular members 108 may be inserted into recesses 106, where recesses 106 are holes through the diameter of rod 100, by heating, lubrication or other means, where the outer diameter of flexible tubular members 108 is greater than the inner diameter of recesses 106. For example, flexible tubular members 108 may be dipped into warm water to facilitate insertion through recesses 106. Based upon the flexible nature of the material comprising flexible tubular members 108, the material may be stretched and its diameter compressed to be able to fit through recesses 106. Once through recess 106, the material may spring back to its original shape such that the diameter of flexible tubular members 108, returning to its original diameter, on either side of recess 106, may act to hold the flexible tubular member 108 in place within recess 106. In some embodiments, flexible tubular members 108 may have one or more angled ends, which may facilitate insertion through recesses 106. Claimed subject matter is not intended to be limited to this particular embodiment.

Flexible tubular members 108 are generally capable of gently removing fruit tree blossoms upon rotation around rod 100, such that damage to the fruit tree, remaining blossoms and/or green fruit, and a blossom cluster's ability to blossom year-to-year is minimal. Flexible tubular members 108 may be the same length, or varied lengths. For example, some embodiments may include flexible tubular members 108 of two or more different lengths, shapes, diameter and/or sizes. Similarly, some embodiments may include flexible tubular members 108 made of two or more different materials. Flexible tubular members 108 are generally shorter than the length 102 of rod 100, and sufficiently short enough to prevent or reduce them from becoming wrapped or entangled about rod 100 during rotational use. In one embodiment, flexible tubular members 108 are 8.5 inches long; however, different lengths are contemplated, and the scope of claimed subject matter is not intended to be limited to a particular length.

Once inserted into recesses 106, flexible tubular members 108 may extend at an angle away from recesses 106 about perimeter 104. In some embodiments, while tool 10 is stationary, flexible tubular members 108 may extend at least partially substantially ninety degrees away from perimeter 104. In other embodiments, while tool 10 is stationary, flexible tubular members 108 may extend at one or more angles less than substantially perpendicular to perimeter 104, or may curve away from recesses 106, as shown in FIG. 1. Due to the material used to comprise flexible tubular members 108 in most embodiments, flexible tubular members 108 generally do not lie flat against length 102 of rod 100 in those embodiments when at rest. Various angles are possible, and unless specified, claimed subject matter is not so limited.

Referring to FIG. 1, tool 10 may also have a sleeve 110. Sleeve 110 may be attached about rod 100. Accordingly, sleeve 110 generally has a diameter and/or perimeter greater than the diameter and/or perimeter of rod 100. For example, in an embodiment having a rod 100 of ½ inch diameter, sleeve 110 may have a ¾ inch diameter. Claimed subject matter is not so limited. Sleeve 110 may be made of various materials, including but not limited to aluminum, polyethylene tubing, synthetic rubber, rubber, steel, alloy, cotton cloth material, fiberglass, and other rigid or non-rigid materials known in the art. Sleeve 110 may be attached to rod 100 by being slid onto rod 110 from one of its ends, such as an end that does not have flexible tubular members 108 extending therefrom. For example, for a rod 100 having a substantially circular perimeter, sleeve 110 may be tubular and have a substantially circular perimeter and be slid onto rod 100 at its end. In other embodiments, sleeve 110 may be wrapped around rod 100 and its ends or other portions affixed together to form a substantially tubular shape. In other embodiments, sleeve 110 may be formed of two demi-perimeter shapes and connected together about rod 100. Sleeve 110 may not be substantially cylindrical in diameter in other embodiments. Various embodiments and connections are possible and within the scope of claimed subject matter.

Sleeve 110 may rotate freely about rod 100. Sleeve 110 may be used as a grip to support rod 100 during rotational use such that sleeve 110 does not rotate with rod 100 during rotational use but instead remains fixed in place with respect to a user's grip. Sleeve 110 may be of various lengths. For example, sleeve 110 is seven inches long in one embodiment. Claimed subject matter is not so limited. In various embodiments, sleeve 110 is located about rod 100 at a location that does not have flexible tubular members 108 extending therefrom. In some embodiments, sleeve 110 may be located about rod 100 at a location along length 102 that does not have recesses 106, but in other embodiments, sleeve 110 may be placed over recesses 102. In various embodiments, a user may change the location of sleeve 110 along length 102 for use.

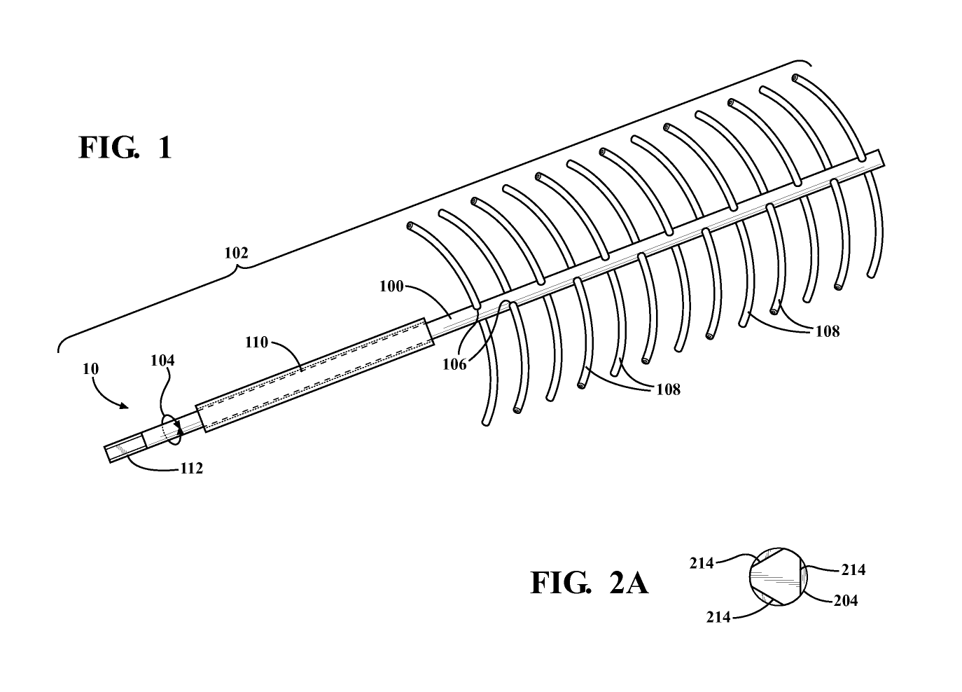

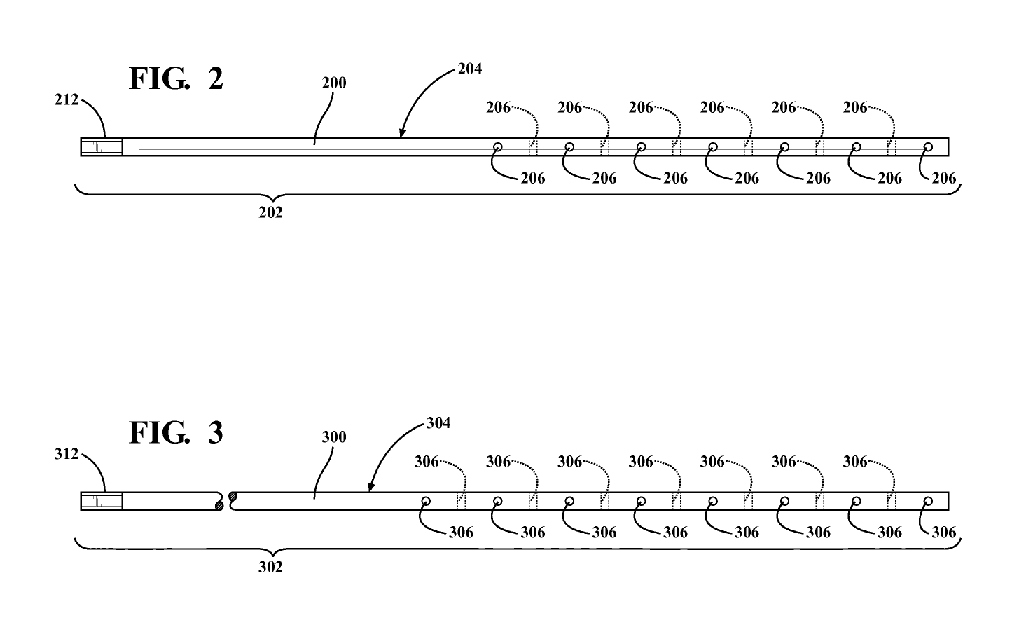

Rod 100 also includes an attachment end 112. Attachment end 112 is capable of removably connecting tool 10 to a rotating power tool, such as but not limited to, a power drill. Attachment end 112 may be machined or otherwise formed into a shape capable of being directly inserted into a clutch of a power drill, as shown in FIG. 2A. For example, as shown in FIG. 2A, for rod 200 having a perimeter 204, the end may be machined to have a perimeter that is smaller than perimeter 204, such that triangular portions 214 are machined out of perimeter 204. In this manner, attachment end 112 may fit directly into the shaft of a rotating power tool, such as a drill, by meeting the curvature of the chuck. For example, attachment end 112 may be machined to be sized similar to a ½ inch drill bit that would also fit into the chuck of the power drill. In various embodiments, attachment end 12 may be adapted to be shaped as a bit to a six point, a star bit or a round stock. Claimed subject matter is not intended to be limited to this particular manner of removably connecting rod 200 to a rotating power tool, such as a drill.

In other embodiments, attachment end 112 may include one or more pieces or adapters to facilitate removable attachment to a rotating power tool. For example, some embodiments may use a threaded attachment piece or other type of attachment piece to facilitate removable connection to the power drill. In various other embodiments, attachment end 112 may be fastened to the rotating power tool by any type of fastener capable of removably connecting rod 100 to the rotating power tool, such as but not limited to, a screw, metal, rivet, clip, springs (such as those that would be used as a door stop), copper tubing, galvanized iron, or a fiberglass driver type. It may be attached by removable adhesives, including tape, such as duct-tape, or by tying it to the rotating power tool with twine, cording or rope, or by many other manners or means of removable connection. Claimed subject matter is not so limited.

Tool 10 may also include an end cap (not shown) located at the end of length 102 opposing attachment end 112. The end cap may act to enclose the interior of rod 100 in hollow embodiments so as to reduce or prevent blossoms or other debris from falling therein.

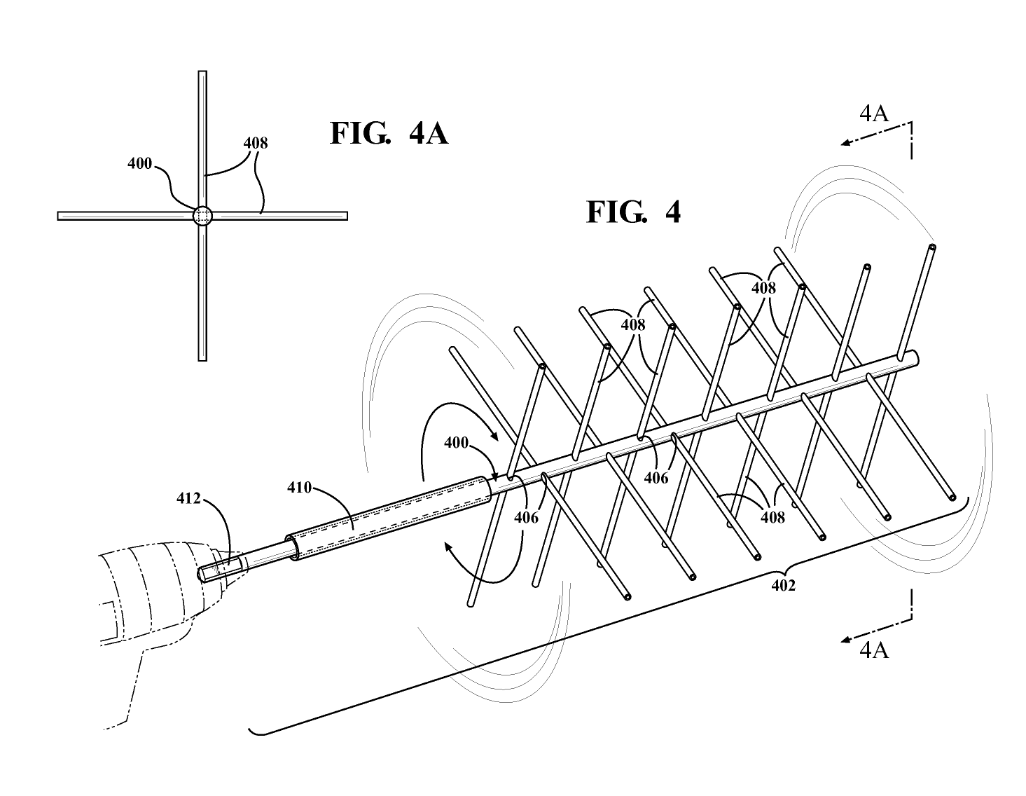

FIGS. 2 and 3 depict two possible embodiments of a blossom thinning tool described herein. FIG. 2 shows rod 200 with recesses spaced at different locations along the length 202 of rod 200 and around the perimeter 204 of rod 200. In this embodiment, the recesses comprise holes 206 extending through rod 200. Holes 206 may be drilled or otherwise formed through the diameter of rod 200 in various embodiments. Holes may be of various interior perimeters, including but not limited to, ⅜ inches in diameter, and other various sizes that allow flexible tubular member 208 to pass therethrough. In an example embodiment, rod 200 may be ½ inch in diameter and two feet in length. In another embodiment, rod 200 may be four feet in length, and a further embodiment includes rod 200 that is six feet in length. However, various lengths, widths, diameters and circumference sizes are possible for rod 200 and holes 206 within the scope of claimed subject matter.

Referring to FIG. 2, in this embodiment, substantially half of the holes 206 are located at a first position about the perimeter 204 of rod 200 and substantially the other half of the holes 206 are located at a second position about the perimeter 204 of rod 200. In this particular example, holes 206 are positioned approximately 2 inches apart along the length 202 of rod 200, such that holes 206 extend along approximately 10 inches of the length 202 of rod 200. Of course, many possible spacings are possible within the scope of claimed subject, and claims are not intended to be limited to this particular embodiment. For example, holes 206 may be evenly spaced along length 202 of rod 200 or unevenly space along length 202 of rod 200 in various embodiments. In this embodiment, holes 206 are positioned substantially ninety degrees apart on the perimeter 204 of rod 200 and located so that every other hole 206 is placed substantially ninety degrees apart from the one or more holes 206 adjacent to it. However, in other embodiments, holes 206 may be positioned at different positions, whether uniformly spaced or unevenly spaced, around the perimeter 204 of rod 200. In this particular embodiment, there are thirteen holes 206. Seven holes 206 are positioned at a first position about the perimeter 204 of rod 200 and six holes 206 are positioned at a second position substantially ninety degrees from or perpendicularly to the first position about the perimeter 204 of rod 200. The overall effect of the spacing and placement of holes 206 in this particular embodiment yields a uniformly spaced pattern of holes 206, but many possible configurations are possible, including configurations that appear randomly spaced rather than uniformly organized. The specific placement of and number of holes in this particular embodiment is not intended to limit claimed subject matter, and many possible numbers, configurations and placements of holes 206 about rod 200 are possible.

Rod 200 also has attachment end 212. In this particular embodiment, attachment end 212 is 1⅛ inches long on length 202 of rod 200. However, attachment end 212 may be of many different lengths, sizes and shapes, and claimed subject matter is not intended to be limited to this particular embodiment.

FIG. 3 shows a second possible embodiment with rod 300 having holes 306. In this embodiment, substantially half of the holes 306 are located at a first position about perimeter 304 of rod 300 and substantially the other half of the holes 306 are located at a second position about perimeter 304 of rod 300. In this particular example, holes 306 are positioned approximately 2 inches apart along length 302 of rod 300, such that holes 306 extend along approximately 14 inches of length 302 of rod 300. Of course, many possible spacings are possible within the scope of claimed subject, and claims are not intended to be limited to this particular embodiment. For example, holes 306 may be evenly spaced along length 302 of rod 300 or unevenly space along length 302 of rod 300 in various embodiments. In this embodiment, holes 306 are positioned substantially ninety degrees apart on the perimeter 304 of rod 300 and located so that every other hole 306 is placed substantially ninety degrees apart from the one or more holes 306 adjacent to it. However, in other embodiments, holes 306 may be positioned at different positions, whether uniformly spaced or unevenly spaced, around the perimeter 304 of rod 300. In this particular embodiment, there are fifteen holes 306. Seven holes 306 are positioned at a first position about the perimeter 304 of rod 300 and eight holes 306 are positioned at a second position substantially ninety degrees from or perpendicularly to the first position about perimeter 304 of rod 300. The overall effect of the spacing and placement of holes 306 in this particular embodiment yields a uniformly spaced pattern of holes 306, but many possible configurations are possible, including configurations that appear randomly spaced rather than uniformly organized. The specific placement of and number of holes in this particular embodiment is not intended to limit claimed subject matter, and many possible numbers, configurations and placements of holes 306 about rod 300 are possible.

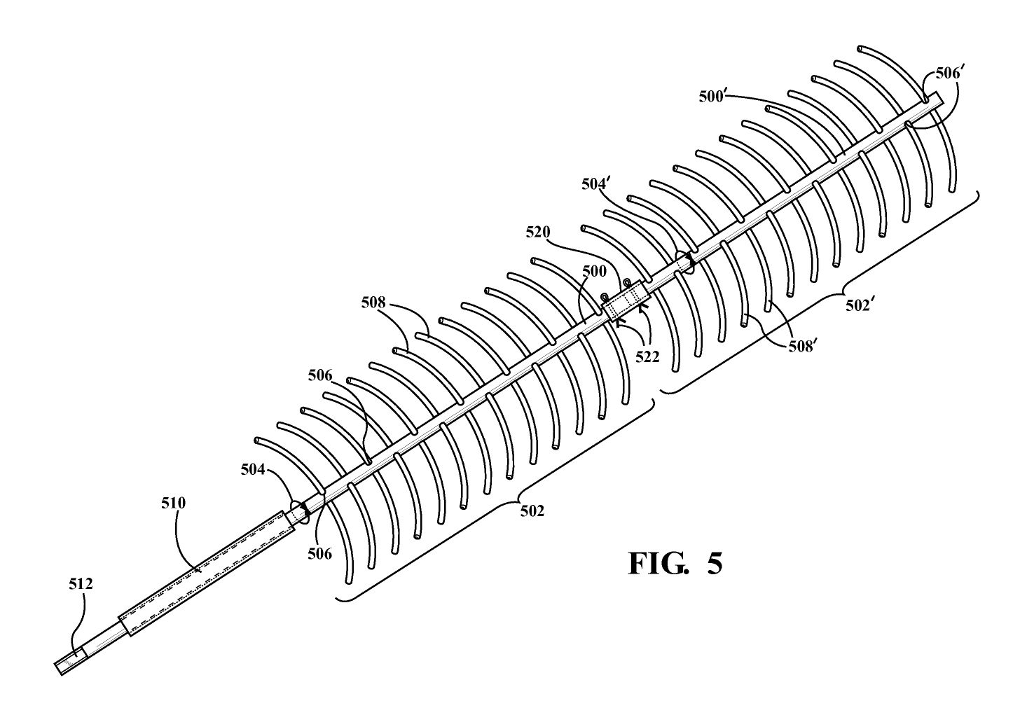

FIGS. 4 and 4A show an embodiment during rotational use. Flexible tubular members 408 extend at angles substantially ninety degrees away from length 402 of rod 400 during rotational use. FIG. 4A is a cross sectional view of FIG. 4, showing flexible tubular members 408 about rod 400 extending at substantially ninety degree angles apart about rod 400. FIG. 4 shows an embodiment where recesses 406 are placed substantially ninety degrees apart; however other relative locations are possible within the scope or spirit of this application. For example, in an embodiment having a substantially circular perimeter, recesses 406 could be positioned substantially 120 degrees apart. Again, these are but two possible examples, and claimed subject matter is not intended to be so limited.

As shown in FIG. 4, attachment end 412 may be inserted into a clutch of a rotating power tool. For example, the tool may be removably connected to a power drill, such as but not limited to an electrically powered drill or battery powered cordless drill. The rotating power tool may be powered to rotate the tool about its perimeter, once the tool is removably connected to it. The rotating power tool may operate at multiple speeds, such that rod 400 may be rotated at different speeds. The handheld rotating power tool may be capable of operating at multiple speeds, including at slower speeds to allow for more gentle blossom removal and reduce or eliminate potential damage to the fruit tree and remaining blossoms. A user may be capable of selecting various speed settings on the rotating power tool.

During rotation, flexible tubular members 408 may swing about the perimeter of rod 400 at a direction substantially perpendicular to it. Flexible tubular members 408 may act as flailing fingers. At slower speeds, flexible tubular members may swing at angles away from the perimeter of rod 400 that may be less than substantially perpendicular to the perimeter. During rotation, flexible tubular members 408 may be placed to contact blossoms. Depending upon placement by a user with respect to a fruit tree during rotational use, each flexible tubular member 408 may be capable of contacting a separate blossom, multiple flexible tubular members 408 may contact the same blossom, one or more flexible tubular members 408 may not come into contact with blossoms while others contact one or more blossoms, or no flexible tubular members may come into contact with any blossoms. In this manner, it is possible for the tool to remove more than one blossom at a time. At higher rotational speeds, flexible tubular members 408 may exert a greater force upon the blossoms than at slower rotational speeds. One or more rotational speeds may be employed such that flexible tubular members 408 remove blossoms upon contact, after a period of time of contact, or after multiple contacts during rotations of flexible tubular members 408. The tool may be rotated at a rotational speed such that if flexible tubular members 408 contact blossoms that are not removed, the blossoms may still be capable of producing mature fruit, capable of blossoming year-to-year, and/or have little or no damage. The tool may be rotated at a rotational speed such that if flexible tubular members 408 remove blossoms, the blossom cluster may still be capable of blossoming year-to-year and/or have little or no damage. Blossoms that do not come into contact with flexible tubular members 408 are generally not removed by the blossom thinning tool. The rotational force of the tool may act to vibrate the tree and knock further blossoms off of the tree that do not contact the blossom thinning tool, but this type of removal is generally minimal, and removal by tree vibration without contact by flexible tubular members 408 is not a primary intended use. Sleeve 410 may be gripped by a user during rotational use, such that it does not rotate with rod 400.

The blossom thinning tool may be placed at various angles and positions relative to a fruit tree during use. For example, the blossom thinning tool may be placed in a substantially vertical position, a substantially horizontal position, or at an angle therebetween during rotational use. It may be moved between multiple angles during rotational use. It may be placed to remove blossoms on an upper canopy, lower canopy, interior portion and/or exterior portion of the fruit tree by a user maneuvering the blossom thinning tool with respect to the fruit tree, without powering down the rotating power tool or detaching or resetting a position of the tool with respect to the rotating power tool. Rotating power tool may move with the blossom thinning tool during use to these various positions relative to the fruit tree.

A user may grip sleeve 410 to support the blossom thinning tool. During rotational use, sleeve 410 may not rotate with rod 400, and may thus be gripped to support the blossom thinning tool. Sleeve 410 may act to insulate a user's hand from becoming too hot and/or cold during use, such as but not limited to, by being comprised of a material that does not thermally conduct. Sleeve 410 may act to prevent or reduce dirt from a user's hand from transferring onto rod 400 from gripping during rotational use. Claimed subject matter is not intended to be so limited.

The rotating power tool may be relatively light weight to allow it to be handheld without significant user fatigue over a period of time, such as but not limited to, a period of time sufficient to remove a desired amount of blossoms from part of a tree, an entire tree, or multiple trees. Using a handheld rotational power tool to power tool 100 may allow for tool 100 to be handheld during use.

Because the blossom thinning tool is substantially lightweight, it may be handheld during use, including during rotational use to remove blossoms. Because it is not fixed in place relative to the fruit tree, it may be moved to numerous angles with respect to the fruit tree during blossom thinning. In this manner, the blossom thinning tool is more maneuverable than prior art mechanical thinners that are tractor drawn, as they are fixed in place relative to the fruit trees until reset to another fixed position. The blossom thinning tool may also access portions of a tree that mechanical thinners cannot access due to their fixed position and large size, such as interior branches, and branches of an unpruned tree. In this manner, all trees do not have to be groomed to the same size and shape for the tool to be effectively used to remove blossoms, whereas prior art mechanical thinners take a pass at a row of trees keeping the thinner at a fixed position relative to the row, requiring the trees to be relatively the same size and shape for effective blossom removal.

During use, flexible tubular members 408 may contact blossoms that are not to be removed in addition to those that are removed. Due at least in part to the flexible nature of flexible tubular members 408 and the rotational speed used for blossom removal, blossoms coming into contact with flexible tubular member 106 during rotational use but not being removed from the fruit tree may still be capable of producing mature fruit. The flexibility of flexible tubular member 408 allows for softer contact with blossoms and is less likely to damage them. Prior art string trimmers having strings made of other materials, such as string or nylon, often may act as whips during rotational use and damage blossoms not intended for removal. Rotating the tool with a handheld power tool also allows for slower rotational speeds which may prevent or diminish damage to blossoms that are not removed.

FIG. 5 shows a further blossom thinning embodiment comprising a multi-rod configuration. In this embodiment, rod 500 has length 502 and perimeter 504. Recesses 506 are capable of accepting flexible tubular members 508 therein. There is a sleeve 510 located about rod 500, and rod 500 has attachment end 512 which is adapted for removable attachment to a rotating power tool. This embodiment contains a second rod 500′, which also has a length 502′, perimeter 504′ and recesses 506′ that are capable of accepting flexible tubular members 508 therein. Rod 500 and rod 500′ may be removably connected via collar 520 to create a longer blossom thinning tool. Lengths 502 and 502′ be of the same length or different lengths in various embodiments. For example, rod 500 may be 4 feet long and rod 500′ may be two feet long, so that when they are removably connected via collar 520, the overall length of the blossom thinning tool is approximately six feet in length. Claimed subject matter is not intended to be limited to a particular length.

In some embodiments, the ends of rods 500 and 500′ may fit inside of collar 520. In some embodiments, rods 500 and 500′ may have threaded ends capable of screwing into collar 520. Rods 500 and 500′ may be retained in collar 520 by the design, configuration and/or shape of collar 520 alone, such as by threaded ends, and/or by fastening means known in the art, such as pins 522. Various other fastening means known in the art, such as but not limited to, screws, pins, locks, latching, threading, buttoning and welding are possible and claimed subject matter is not so limited. In some embodiments, the end of rod 500′ capable of being retained by collar 520 may also be an attachment end (not shown) capable of being removably attached to a rotating power tool, such as but not limited to, by being machined to fit into a rotating power drill clutch, as described above.

In this sense, this blossom thinning tool embodiment may have three different configurations removably connected to a rotating power tool: rod 500, rod 500′ and/or rods 500 and 500′. Other embodiments may include further rods that may be removably connected to rod 500 and/or 500′. For example, there may be a second collar capable of being removably connected to the opposing end of rod 500′ to connect a third rod to the blossom thinning device. In this manner, a blossom thinning tool may have different possible lengths, and the length thereof may be changed by a user. A user may desire different operating lengths to reach different parts of a tree, shrub, bush or other plant during thinning. A user may desire different operating lengths for the tool depending upon the type of tree, bush and/or shrub on which it is to be used for blossom and/or green fruit thinning. Other numbers of rods are possible in various embodiments. In some embodiments, sleeve 510 may be removed from rod 500 and placed upon rod 500′ or other rods.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of claimed subject matter is not limited in these respects. It should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A thinning apparatus, comprising:
a rod comprising a length, a perimeter, a plurality of recesses spaced at multiple locations along said length and spaced at one or more positions around said perimeter, and an attachment end configured to removably attach said rod to a handheld rotating power tool;
a plurality of flexible tubular members attached to said rod in said recesses;
said rod is configured to be rotated by said rotating power tool about said perimeter;
said flexible tubular members are configured to be placed in contact with one or more blossoms and removing said one or more blossoms by said contact during said rotation; and
said apparatus is configured to be handheld, including during said rotation and said removal, and being manually maneuvered to multiple angles with respect to said one or more blossoms or green fruit during said rotation and said removal.

2. The apparatus of claim 1, said plurality of recesses further comprise a plurality of holes that each extend through a diameter of said rod, said flexible tubular members are attached to said rod by being placed through one of said holes and said holes are configured to retain said flexible tubular members therein.

3. The apparatus of claim 2, said flexible tubing members are comprised of a resilient material configured to stretch to be placed through said holes and rebound to be retained within said holes without fasteners.

4. The apparatus of claim 2, substantially half of said holes are spaced along said length of said rod at a first location on said perimeter of said rod and substantially the other half of said holes are spaced at a position substantially ninety degrees from said first position about said perimeter of said rod.

5. The apparatus of claim 2, said rod comprises a solid interior through which said holes are machined.

6. The apparatus of claim 1, further comprising a sleeve attached to said rod, said sleeve is located on said rod around a perimeter portion of said rod that does not have said flexible tubular members extending therefrom, said sleeve does not rotate with said rod during said rotation, and said sleeve is configured to be used as a grip for a user to hold onto during said rotation and said removal.

7. The apparatus of claim 1, said recesses are spaced at equal distances from each other along said length of said rod.

8. The apparatus of claim 1, said perimeter of said rod is substantially circular in shape.

9. The apparatus of claim 1, said plurality of flexible tubular members further comprise an angled end portion.

10. The apparatus of claim 1, said plurality of flexible tubular members are comprised of polyethylene tubing.

11. The apparatus of claim 1, said plurality of flexible tubular members are configured to remove more than one blossom at the same time.

12. The apparatus of claim 1, further comprising:
a second said rod and a collar; said collar is capable of removably connecting said second rod to said rod.

13. The apparatus of claim 12, said second rod has a different length than said rod.

14. The apparatus of claim 12, said second rod may be removably connected directly to said rotating power tool instead of being connected to said rod.

15. A handheld thinning apparatus comprising:
a rod comprising a length, a perimeter and an attachment end that is adapted to removably connect said rod to a handheld rotating power tool;
a plurality of flexible tubular members attached to said rod at more than one location along said length and at more than one location around said perimeter;
said rod is configured to be rotated by said rotating power tool in a circular manner about said perimeter;
said plurality of flexible tubular members are configured to be placed in contact with more than one blossom at the same time during rotational use, and are configured to remove said more than one blossom by said contact;
said apparatus is adapted to be handheld, including during said rotation and said blossom removal;
said apparatus is configured to be manually maneuvered during rotational use to multiple angles with respect to a plant for said blossom removal; and
said apparatus is configured to be used to selectively remove some of said blossoms and leave other said blossoms intact on said plant.

16. The apparatus of claim 15, said apparatus is capable of, during rotational use, being used to thin blossoms on an upper canopy, lower canopy, interior portion and exterior portion of a fruit tree by a user maneuvering said apparatus with respect to said plant without powering down said rotating power tool, or detaching or resetting a position of said apparatus with respect to said rotating power tool.

17. The apparatus of claim 15, said rod further comprises holes extending through a diameter of said rod, said flexible tubular members are attached to said rod by being placed through said holes.

18. The apparatus of claim 15, said attachment end is adapted to fit into a clutch of a power drill.

19. The apparatus of claim 15 further comprising a sheath removably positioned around a portion of said perimeter, said flexible tubular members are attached to said rod by being connected to said sheath, and said sheath is adapted to be rotated with said rod by said rotating power tool.

20. The apparatus of claim 15 further comprising a second rod comprising a second length, a second perimeter and a second attachment end, a plurality of said flexible tubular members are attached to said second rod at more than one location along said second length and at more than one location around said second perimeter; said second rod is adapted to be removably connected to said rod; and said second attachment end is adapted to be removably attached to said rotating power tool.

21. A method of blossom removal, comprising:
rotating with a rotating power tool a handheld apparatus comprising a rod comprising a length, a perimeter, an attachment end that is adapted to removably connect said rod to a handheld rotating power tool, and a plurality of flexible tubular members attached to said rod at more than one location along said length and at more than one location around said perimeter;
placing at least some of said flexible tubing members in contact with one or more blossoms on a plant;
removing at least some of said blossoms from said plant; and
manually maneuvering said rod during rotational use to multiple angles with respect to said plant for said blossom removal.

22. The method of claim 21 further comprising manually maneuvering said rod during rotational use to remove some of said blossoms from an upper canopy, a lower canopy, an interior portion and an exterior portion of a plant without powering down said rotating power tool, or detaching or resetting a position of said rod with respect to said rotating power tool.

23. The method of claim 21 further comprising holding said apparatus during rotational use by gripping a sleeve attached to said rod, said sleeve is located on said rod around a perimeter portion of said rod that does not have said flexible tubular members extending therefrom, and said sleeve does not rotate with said rod during said rotation.

24. The method of claim 21 further comprising removably attaching a second rod comprising a second length, a second perimeter and a second attachment end, and having a second plurality of said flexible tubular members attached to said second rod at more than one location along said second length and at more than one location around said second perimeter, to said rod to extend the length of said apparatus.
